(19) United States
(12) Patent Application Publication
(10) Pub. No.: US 2026/0299554 A1
(43) Pub. Date: Oct. 1, 2026

(54) NUMERICAL CONTROL DEVICE AND NUMERICAL CONTROL SYSTEM

(71) Applicant: FANUC CORPORATION, Yamanashi (JP)

(72) Inventor: Kazutaka IMANISHI, Yamanashi (JP)

(73) Assignee: FANUC CORPORATION, Yamanashi (JP)

(21) Appl. No.: 19/480,922

(22) PCT Filed: May 10, 2023
(86) PCT No.: PCT/JP2023/017629

§ 371 Date: Nov. 3, 2025

(51) Int. Cl. G05B 19/409

(52) U.S. Cl. CPC G05B 19/409; G05B 2219/39001; G05B 2219/40161

(57) ABSTRACT

The present invention provides a technique that can easily connect an external device to a numerical control device and easily operate the external device from the numerical control device. This numerical control device is connected to an external device via a control device and controls the external device by using a numerical control program. The numerical control device includes: a signal unit for controlling the action of the numerical control device in accordance with a signal state; a control path selection unit for selecting a control path in accordance with an input from the signal unit; a display/operation unit for performing state display and operation on the numerical control device; an external device control path selection/operation unit that makes it possible to select an external device control path by notifying the signal unit in accordance with a selection operation for the external device control path, and to operate the external device control path by notifying the signal unit in accordance with an operation during selection of the external device control path; an analysis unit that analyzes an external device control command in a numerical control program while the external device control path is running; an external device command signal generation unit that generates an external device command signal in accordance with the external device control command; and a transmission/reception unit that transmits the external device command signal to the control device.

### TECHNICAL FIELD

The present disclosure relates to a numerical control device and a numerical control system.

### BACKGROUND ART

Generally, a numerical control program for controlling a machine tool and a robot program for controlling a robot differ from each other in program language. Therefore, an operator is required to master both numerical control programs and robot programs to allow an action of a machine tool and an action of a robot to be linked to each other.

To facilitate automation in a machining site, such a numerical control system has been demanded in recent years that controls in a linked manner an action of a machine tool that machines a workpiece and an action of a robot provided near the machine tool (for example, see Patent Document 1). In the numerical control system, a user who has mastered a machine tool uses a numerical control program for the machine tool to control a robot.

### CITATION LIST

### Patent Document

Patent Document 1: Japanese Patent No. 5752179

### DISCLOSURE OF THE INVENTION

### Problems to Be Solved by the Invention

By the way, in conventional techniques, it has been necessary to additionally provide a control path selection key on an operation board of a machine tool for adding a control path for a numerical control device. Furthermore, an input/output (I/O) device and a ladder circuit have also been necessary for inputting a pressed state of the control path selection key to the numerical control device for selecting the control path. In addition, it has also been necessary to perform an input to the numerical control device from keys provided on the operation board of the machine tool via the I/O device and the ladder circuit for performing switching to a program editing mode for control path selection or an automatic running (memory running) mode and for performing a starting or stopping operation for program running, for example.

Therefore, since, for example, to add a means for selection of a robot control path, selection of an action mode, and start or stop of running when a robot serving as an external device is to be coupled to a numerical control device, it is necessary to add keys on an operation board of a machine tool, an I/O device, and a ladder circuit, there have been such issues that coupling of an external device such as a robot is not easy and the external device such as the robot is not easily operated from the numerical control device.

In view of the situations described above, an object of the present disclosure is to provide a technique that makes it possible to easily couple an external device such as a robot to a numerical control device and to easily operate the external device such as the robot from the numerical control device.

### Means for Solving the Problems

The present disclosure is directed to a numerical control device that is coupled to an external device via a control device and controls the external device by using a numerical control program, the numerical control device including: a signal unit that controls an action of the numerical control device in accordance with a signal state; a control path selection unit that selects a control path designated from a plurality of control paths including a control path for the external device in accordance with an input from the signal unit; a display/operation unit that allows state display of and an operation on the numerical control device; an external device control path selection/operation unit that provides, when a selection operation for the control path for the external device is performed on the display/operation unit, to the signal unit, a notification about switching to the control path for the external device to make the control path for the external device selectable and that provides, when an operation is performed on the display/operation unit while the control path for the external device is selected, a notification to the signal unit in accordance with the operation to make the control path for the external device operable; an analysis unit that analyzes an external device control command in the numerical control program during running of the control path for the external device; an external device command signal generation unit that generates, in accordance with the external device control command that the analysis unit has analyzed, an external device command signal for executing an action of the external device; and a transmission/reception unit that transmits, to the control device, the external device command signal that the external device command signal generation unit has generated.

Furthermore, the present disclosure is further directed to a numerical control system including the numerical control device and a control device that is coupled to the numerical control device and controls the external device.

### BRIEF DESCRIPTION OF THE DRAWINGS

FIG. 1 is a schematic diagram of a numerical control system according to an embodiment of the present disclosure;

FIG. 2 is a functional block diagram of the numerical control system according to the embodiment of the present disclosure; and

FIG. 3 is a sequence diagram illustrating an example of a flow of processing that the numerical control system according to the embodiment of the present disclosure executes.

### PREFERRED MODE FOR CARRYING OUT THE INVENTION

An embodiment of the present disclosure will now be described herein in detail with reference to the accompanying drawings.

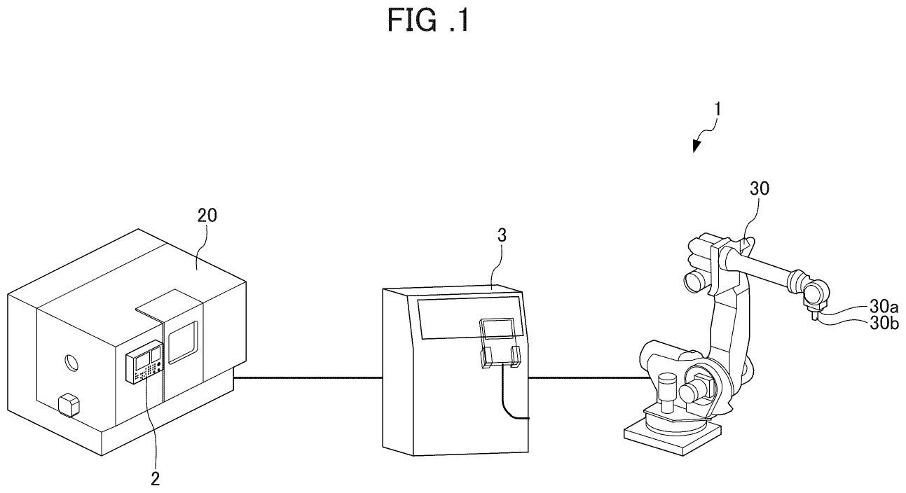

FIG. 1 is a schematic diagram of a numerical control system 1 according to the embodiment of the present disclosure. As illustrated in FIG. 1, the numerical control System 1 according to the present embodiment includes a machine tool 20 that machines a workpiece, a numerical control device 2 that controls an action of the machine tool 20, a robot 30 that is provided near the machine tool 20 and serves as an external device, and a robot control device 3 that controls an action of the robot 30. The numerical control system 1 uses the numerical control device 2 and the robot control device 3 that are communicably coupled to each other to control in a linked manner actions of the machine tool 20 and the robot 30.

The machine tool 20 is, but not limited to, for example, a lathe, a drilling machine, a milling machine, a grinding machine, a laser processing machine, or an injection molding machine. The machine tool 20 executes, in accordance with various types of command signals transmitted from the numerical control device 2, various types of actions including, for example, a machining action on a workpiece, an opening or closing action of a chuck holding the workpiece, and an opening or closing action of a door provided in a machining area for the workpiece.

The robot 30 acts under control by the robot control device 3, and executes, for example, a predetermined task on the workpiece that the machine tool 20 machines. The robot 30 is, for example, a six-axis multi-joint robot having an arm tip portion 30a for holding the workpiece or for attaching a tool 30b for machining or inspection.

The numerical control device 2 and the robot control device 3 are computers each including pieces of hardware including an arithmetic processing means such as a central processing unit (CPU), an auxiliary storage means such as a hard disk drive (HDD) or a solid state drive (SSD) storing various types of programs, a main storage means such as a random access memory (RAM) for storing data temporarily required when the arithmetic processing means executes a program, an operation means such as a keyboard that an operator performs various types of operations, and a display means such as a display that displays various types of pieces of information for the operator. A function and an action of each of functional portions described later are achieved as the CPU and the memory installed in the computer described above and a control program stored in the memory cooperate with each other. The numerical control device 2 and the robot control device 3 are able to mutually transmit and receive various types of signals via an Ethernet (registered trademark), for example. Furthermore, the numerical control device 2 according to the present embodiment may include a computer numerical controller (CNC) in which a programmable logic controller (PLC) is built in.

The numerical control system 1 according to the present embodiment is, but not limited to, for example, one in which the robot 30 is additionally provided to the machine tool 20 that has already been provided. To control in a linked manner an action of the machine tool 20 and an action of the robot 30, for example, the numerical control system 1 according to the present embodiment is configured to allow the robot control device 3 to provide an action request to the numerical control device 2 to make it possible to allow the robot control device 3 to read and write variables related to the numerical control device 2.

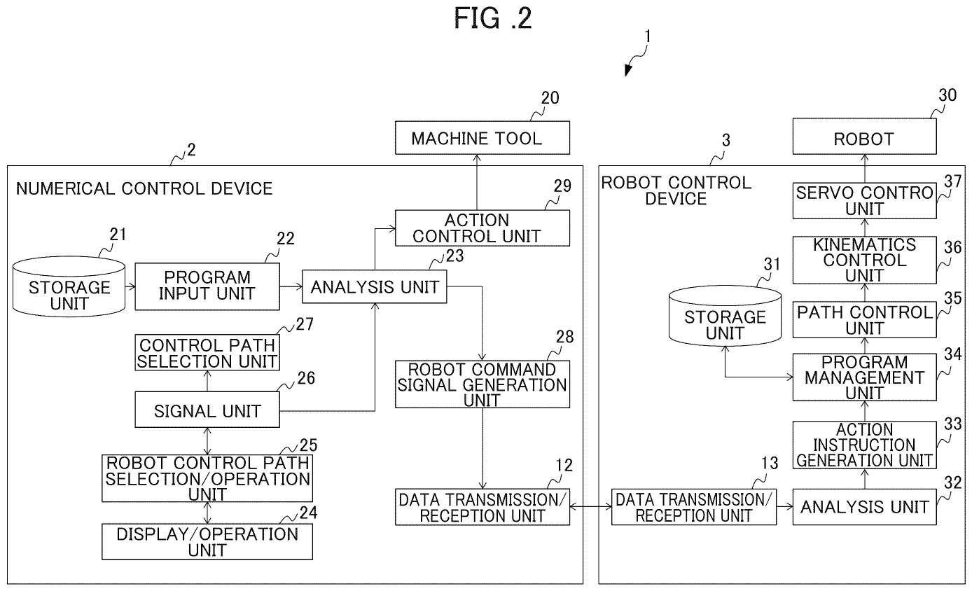

FIG. 2 is a functional block diagram of the numerical control system 1 according to the present embodiment.

A detailed configuration of the numerical control device 2 will now first be described herein. As illustrated in FIG. 2, the numerical control device 2 is provided with the functional portions that vary in type based on the hardware configuration described above. Specifically, the numerical control device 2 includes a storage unit 21, a program input unit 22, an analysis unit 23, a display/operation unit 24, a robot control path selection/operation unit 25, a signal unit 26, a control path selection unit 27, a robot command signal generation unit 28, an action control unit 29, and a data transmission/reception unit 12.

The storage unit 21 has stored numerical control programs for controlling, as actions of the machine tool 20, for example, a movement action of a control shaft, a rotation action of a main shaft, an opening or closing action of the chuck, and an opening or closing action of the door. The numerical control programs stored in the storage unit 21 have been created by the operator beforehand and described in a program language by using a G code or an M code for controlling in a linked manner an action of the robot 30 under the control by the robot control device 3 and an action of the machine tool 20. Furthermore, the storage unit 21 has further stored numerical control programs for controlling actions of the robot 30.

The program input unit 22 reads a numerical control program from the storage unit 21. Furthermore, the program input unit 22 successively inputs the read numerical control program to the analysis unit 23.

The analysis unit 23 sequentially analyzes, per block, a type of a command based on the numerical control program inputted from the program input unit 22. Furthermore, the analysis unit 23 outputs a result of the analysis to the robot command signal generation unit 28 or the action control unit 29 described later.

The analysis unit 23 outputs, when, for example, a type of the command acquired based on the numerical control program is one that commands opening or closing of the chuck of the machine tool 20 or one that commands opening or closing of the door of the machine tool 20, the acquired command to the action control unit 29. As such a command is inputted from the analysis unit 23, the action control unit 29 inputs an I/O signal in accordance with the inputted command to the machine tool 20. Thereby, the chuck or the door of the machine tool 20 is opened or closed in accordance with a procedure that the numerical control program designates.

When the type of the command acquired based on the numerical control program is one that commands movement of the control shaft of the machine tool 20, for example, the analysis unit 23 outputs the acquired command to the action control unit 29. As the command is inputted from the analysis unit 23, the action control unit 29 performs interpolation processing to calculate a movement route of the control shaft in accordance with the command and performs feedback control on each of servo motors of the machine tool 20 to allow the control shaft to move along the calculated movement route. Thereby, the action of the machine tool 20 is controlled in accordance with the procedure that the numerical control program designates.

Furthermore, the analysis unit 23 analyzes the numerical control program during running of a robot control path (that may also be hereinafter simply referred to as a robot control path.) and analyzes a robot control command included in the numerical control program. When the type of the acquired command is a robot control command as the result of the analysis, the analysis unit 23 outputs the acquired command to the robot command signal generation unit 28.

The display/operation unit 24 allows state display of and an operation on the numerical control device 2. The display/operation unit 24 includes soft keys, a display, and a touch panel display. The display/operation unit 24 accepts and displays each of various types of operations that the operator provides, such as a switching selection operation to the robot control path (when one is designated beforehand as the robot control path, the designated control path), each of various types of operations for the robot control path, a switching selection operation to another control path than the robot control path, a switching operation to one of various types of action modes for a numerical control program for the robot control path, and a changing operation of an action speed override value for the robot control path.

When a selection operation for the robot control path is performed on the display/operation unit 24, the robot control path selection/operation unit 25 provides, to the signal unit 26, a notification about switching to the robot control path to make the robot control path selectable. Furthermore, when an operation is performed on the display/operation unit 24 while the robot control path is selected, a notification is provided to the signal unit 26 in accordance with the operation to make the robot control path operable.

Note herein that, in the machine tool 20, a plurality of control paths are disposed, such as, Machining control Path 1 (a first control path), Machining control Path 2 (a second control path), a final control path. In particular, when an external device such as the robot 30 is to be additionally provided to the machine tool 20, a control path for the external device, such as the robot control path, is disposed as the final control path for easily additionally providing a control path. In this case, when a selection operation for the robot control path is performed on the display/operation unit 24, the robot control path selection/operation unit 25 provides, to the signal unit 26, a notification about switching to the final control path as a designated control path.

When a selection operation for another control path is performed on the display/operation unit 24 while the robot control path is selected, the robot control path selection/operation unit 25 provides, to the signal unit 26, a notification about switching to the other control path to make the other control path selectable. Examples of the other control path include, in addition to the machining control paths for the machine tool 20 described above, a control path for an external device other than the robot 30.

When a selection operation for at least one action mode among an editing mode for a numerical control program for the robot control path, a manual running mode, and an automatic running mode based on the numerical control program is performed on the display/operation unit 24, the robot control path selection/operation unit 25 provides, to the signal unit 26, a notification about switching to the action mode. Thereby, it is possible to change an action mode in a numerical control program for the robot control path.

When an operation for starting or stopping running based on a numerical control program for the robot control path is performed on the display/operation unit 24, the robot control path selection/operation unit 25 provides, to the signal unit 26, a notification about starting or stopping of running based on the numerical control program for the robot control path. Thereby, it is possible to execute starting or stopping of running of the robot 30 based on a numerical control program for the robot control path.

When a changing operation of an action speed override value for the robot control path is performed on the display/operation unit 24, the robot control path selection/operation unit 25 provides, to the signal unit 26, a notification about changing of the action speed override value for the robot control path. Thereby, it is possible to update an action speed override value for the robot control device 3 to change an action speed override value for the robot 30.

The signal unit 26 controls an action of the numerical control device 2 in accordance with a signal state inputted from the robot control path selection/operation unit 25. Specifically, the signal unit 26 outputs, to the analysis unit 23, the robot control path selection/operation unit 25, or the control path selection unit 27, a signal in accordance with each of various types of notifications from the robot control path selection/operation unit 25, such as a switching notification to the robot control path (when one is designated beforehand as the robot control path, the designated control path), an operation notification for the robot control path, a switching notification to another control path than the robot control path, a switching notification to one of various types of action modes for a numerical control program for the robot control path, and a changing notification of an action speed override value for the robot control path.

The control path selection unit 27 selects a control path designated from the plurality of control paths including the robot control path in accordance with an input from the signal unit 26. Specifically, the control path selection unit 27 selects, in accordance with an input from the signal unit 26, a machining control path among the plurality of machining control paths in the machine tool 20, the robot control path, or a control path for an external device other than the robot 30 and enables an operation of the selected control path.

The robot command signal generation unit 28 generates a robot command signal for executing an action of the robot 30 in accordance with the robot control command that the analysis unit 23 has analyzed. A robot command signal to be generated may include a robot program start command serving as a trigger for starting a robot program stored in a storage unit 31 in the robot control device 3. The robot command signal generation unit 28 outputs the generated robot command signal to the data transmission/reception unit 12.

When the type of the command in the numerical control program that the analysis unit 23 has analyzed is a machining control path command for the machine tool 20, the action control unit 29 generates a machining command signal in accordance with the machining control path command to control the machine tool 20.

The data transmission/reception unit 12 mutually transmits and receives various types of commands and pieces of data together with a data transmission/reception unit 13 in the robot control device 3. When the robot command signal that the robot command signal generation unit 28 has generated is written, the data transmission/reception unit 12 transmits the robot command signal to the robot control device 3. Thereby, the robot control device 3 receives the robot command signal to make it possible to control the robot 30.

Next, a detailed configuration of the robot control device 3 will now be described herein. As illustrated in FIG. 2, the robot control device 3 is provided with various types of functional portions based on the hardware configuration described above. Specifically, the robot control device 3 includes the data transmission/reception unit 13, the storage unit 31, an analysis unit 32, an action instruction generation unit 33, a program management unit 34, a path control unit 35, a kinematics control unit 36, and a servo control unit 37.

The data transmission/reception unit 13 receives the robot command signal transmitted from the data transmission/reception unit 12 in the numerical control device 2. The data transmission/reception unit 13 successively outputs the received robot command signal to the analysis unit 32.

The analysis unit 32 analyzes the robot command signal inputted from the data transmission/reception unit 13. The analysis unit 32 outputs a result of the analysis to the action instruction generation unit 33 described later.

The action instruction generation unit 33 generates a robot instruction in accordance with the robot command signal based on the result of the analysis of the robot command signal inputted from the analysis unit 32. The action instruction generation unit 33 outputs the generated robot instruction to the program management unit 34.

When the robot instruction is inputted from the action instruction generation unit 33, the program management unit 34 successively executes the robot instruction, generates an action plan for the robot 30 in accordance with the robot command signal, and outputs the generated action plan to the path control unit 35 described later.

Furthermore, when the robot instruction inputted from the action instruction generation unit 33 is a block robot instruction, the program management unit 34 adds the inputted block robot instruction to the robot program stored in the storage unit 31. Thereby, in the storage unit 31, the robot program in accordance with the robot command signal transmitted from the numerical control device 2 is generated and stored. The stored robot program is started and run as the program management unit 34 receives a robot program start command as a robot instruction.

When the action plan is inputted from the program management unit 34, the path control unit 35 calculates time-series data for control points for the robot 30 and outputs the calculated time-series data to the kinematics control unit 36.

The kinematics control unit 36 uses inverse kinematic computation to calculate a target angle of each of joints of the robot 30 based on the inputted time-series data and outputs the calculated target angle to the servo control unit 37. Note herein that the inverse kinematic computation for the robot 30 refers to a method for calculating an angle of each of the joints from a position of a tip of a hand and a posture of the robot 30.

The servo control unit 37 performs feedback control for allowing each of the servo motors of the robot 30 to achieve a target angle inputted from the kinematics control unit 36 to generate a robot control signal for the robot 30 and inputs the generated robot control signal to each of the servo motors of the robot 30.

A summary of the flow of actions of the numerical control system 1 according to the present embodiment including the numerical control device 2 and the robot control device 3 having the configurations described above is as follows.

As the operator performs an input from the display/operation unit 24 in the numerical control device 2 to the robot control path selection/operation unit 25, the robot control path selection/operation unit 25 first provides a notification to the signal unit 26 in accordance with the input. When a selection of the robot control path is notified, the signal unit 26 provides, to the control path selection unit 27, a notification about the selection of the robot control path to enable an operation for the robot control path.

Furthermore, when a selection of an action mode for the robot control path is notified, the signal unit 26 performs a change in action mode for the robot control path. Furthermore, when running start of the robot control path is notified, the signal unit 26 starts program running of the robot control path.

On the other hand, the analysis unit 23 analyzes a numerical control program, extracts a robot control command, and notifies the robot command signal generation unit 28 of the extracted robot control command. The robot command signal generation unit 28 generates a robot command signal corresponding to the notified robot control command and transmits the generated robot command signal to the control device 3 via the data transmission/reception unit 12.

The control device 3 causes the analysis unit 32 to analyze the received robot command signal and notifies the action instruction generation unit 33 of a result of the analysis. The action instruction generation unit 33 generates an action instruction in accordance with the robot command signal and notifies the program management unit 34 of the generated action instruction. The program management unit 34 successively executes the action instruction in accordance with an order of generation and, when the action instruction is a movement instruction, generates an action plan for the robot 30 and notifies the path control unit 35 of the generated action plan.

The path control unit 35 follows the inputted action plan to calculate time-series data for control points for the robot 30 and notifies the kinematics control unit 36 of the calculated time-series data. The kinematics control unit 36 follows the time-series data for the control points to calculate an angle of each of the joints from the position of the tip of the hand of the robot 30, sets the calculated angle as a target angle, and notifies the servo control unit 37 of the set target angle. The servo control unit 37 follows the target angle and controls each of the servo motors of the robot 30 to change the angle of each of the joints.

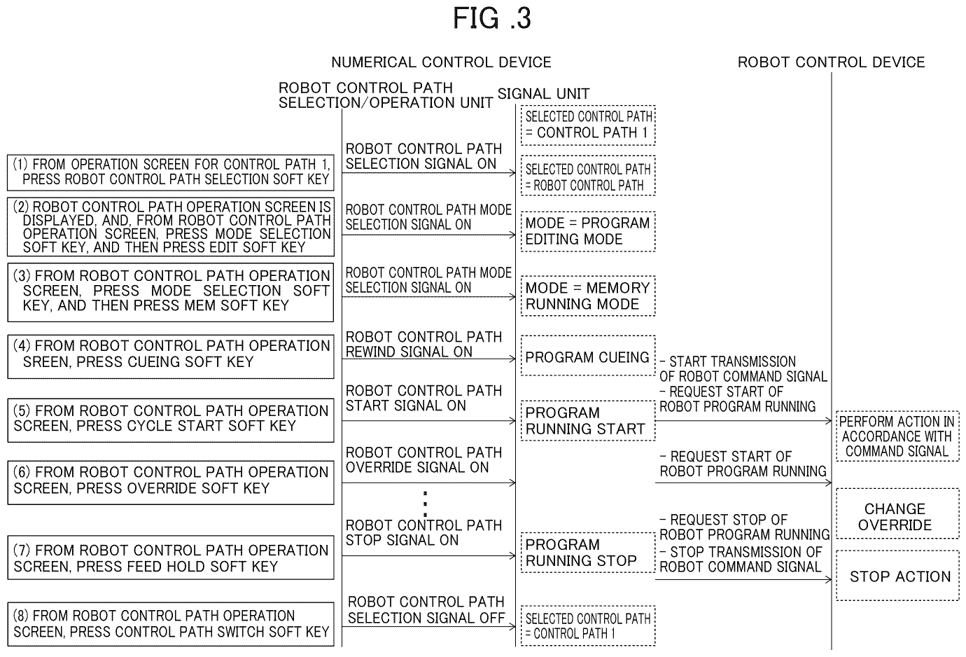

Next, a flow of robot path selection processing that the numerical control system 1 according to the present embodiment executes will now be described herein in detail with reference to FIG. 3. Note herein that FIG. 3 is a sequence diagram illustrating an example of a flow of processing that the numerical control system 1 according to the present embodiment executes. Each of (1) to (8) in the processing, which are indicated in the sequence diagram illustrated in FIG. 3, will now be described herein. Note that, in the present example, it is assumed that a robot control path selection soft key is provided on an operation screen for Machining control Path 1 in the numerical control device 2 and various types of soft keys for robot control path operations are provided on an operation screen for a robot control path.
(1) As a power supply to the numerical control device 2 is first turned ON, Machining control Path 1, for example, is selected as an initial setting, and the operation screen for Machining control Path 1 is displayed. As the operator presses the robot control path selection soft key from the operation screen for Machining control Path 1, switching occurs to a robot control path operation screen, and a robot control path selection ON signal is outputted from the robot control path selection/operation unit 25 to the signal unit 26. Thereby, the control path selection unit 27 selects the robot control path to enable an operation of the robot control path.
(2) Next, when a mode selection soft key is pressed from the robot control path operation screen, a mode selection screen is displayed, and, when an EDIT soft key is pressed from the mode selection screen, a robot control path mode selection ON signal is outputted from the robot control path Selection/operation unit 25 to the signal unit 26. Thereby, a program editing mode is selected to allow editing of the robot program.
(3) Furthermore, similarly, when a MEM soft key is pressed from the mode selection screen displayed when the mode selection soft key is pressed from the robot control path operation screen, a robot control path mode selection ON signal is transmitted from the robot control path selection/operation unit 25 to the signal unit 26. Thereby, a memory running mode is selected, reaching a state where execution of the automatic running mode of the robot 30 is possible.
(4) Furthermore, when a cueing soft key is pressed from the robot control path operation screen, a robot control path rewind ON signal is outputted from the robot control path selection/operation unit 25 to the signal unit 26. Thereby, cueing of the robot program is executed.
(5) Next, when a cycle start soft key is pressed from the robot control path operation screen, a robot control path start ON signal is outputted from the robot control path selection/operation unit 25 to the signal unit 26. Then, the robot command signal that the robot command signal generation unit 28 has generated is transmitted to the robot control device 3, and start of automatic running of the robot program is requested. Thereby, an automatic running action of the robot 30 starts in accordance with the robot command signal.
(6) Next, when an override soft key is pressed from the robot control path operation screen, a robot control path override ON signal is outputted from the robot control path selection/operation unit 25 to the signal unit 26. Then, a change signal for a robot action speed override value is transmitted to the robot control device 3, changing the robot action speed override value.
(7) Next, when a feed hold soft key is pressed from the robot control path operation screen, a robot control path stop ON signal is outputted from the robot control path selection/operation unit 25 to the signal unit 26. Then, the robot command signal that the robot command signal generation unit 28 has generated is transmitted to the robot control device 3, and stop of running of the robot program is requested. Thereby, transmission of a robot command signal is stopped, stopping the automatic running action of the robot 30.
(8) Next, when a control path switch soft key is pressed from the robot control path operation screen, a robot control path selection OFF signal is outputted from the robot control path selection/operation unit 25 to the signal unit 26. Then, the original control path that has been set as the initial setting in the control path selection unit 27, that is, Machining control Path 1, is selected, and the control control path switches from the robot control path to Machining control Path 1, enabling an operation of Machining control Path 1.

According to the present embodiment, it is possible to achieve effects described below.

In the present embodiment, the signal unit 26 that controls an action of the numerical control device 2 in accordance with a signal state, the control path selection unit 27 that selects a control path designated in accordance with an input from the signal unit 26, the display/operation unit 24, the robot control path selection/operation unit 25 that provides, when a selection operation for the robot control path is performed, to the signal unit 26, a notification about switching to the robot control path to make the robot control path selectable and provides, to the signal unit 26, a notification in accordance with an operation while the robot control path is selected to make the robot control path operable, the analysis unit 23, the robot command signal generation unit 28 that generates a robot command signal in accordance with the analyzed robot control command, and the data transmission/reception unit 12 that transmits the robot command signal to the robot control device 3 have been provided. Thereby, since, when the robot 30 is to be coupled to the numerical control device 2, selection of the robot control path is possible in the numerical control device 2 without adding a key on the operation board of the machine tool 20, an I/O device, or a ladder circuit, it is possible to easily couple the robot 30 and to easily perform an operation of the robot 30 from the numerical control device 2.

Furthermore, in the present embodiment where the robot control path selection/operation unit 25 has been configured to provide a switching notification to the robot control path (when one is designated beforehand as the robot control path, the designated control path), an operation notification of the robot control path, a switching notification to another control path than the robot control path, a switching notification to one of various types of action modes for a numerical control program for the robot control path, and a changing notification of the action speed override value for the robot control path, when the robot 30 is to be coupled to the numerical control device 2, it is possible to select the robot control path, it is possible to select an action mode, it is possible to start or stop running, and it is possible to change the action speed override value without adding a key on the operation board of the machine tool 20, an I/O device, or a ladder circuit, making it possible to further easily couple the robot 30 and to further easily perform an operation of the robot 30 from the numerical control device 2.

Although the present disclosure has been described in detail, the present disclosure is not limited to each embodiment described above. It is possible to variously make additions, replacements, modifications, and partial deletions, for example, in the embodiment without departing from the gist of the present disclosure or without departing from the scope of the present disclosure, which is derived from the contents described in Claims and their equivalents. Furthermore, it is possible to implement the embodiment in a combined manner. For example, in the embodiment described above, the order of actions and the order of steps in the processing are indicated as mere examples, and the present disclosure is not limited to the embodiment. Furthermore, the same applies to cases where a numerical value or a numerical expression is used to describe the embodiment described above.

Furthermore, although the robot 3 has been used as an external device in the embodiment described above, the present disclosure is not limited to this case. For example, it is possible to use, as an external device, a loader or a part feeder having a two-axis or three-axis configuration.

Regarding the embodiment described above and modification examples, notes described below are further disclosed.

### Note 1

A numerical control device (2) that is coupled to an external device (30) via a control device (3) and controls the external device (30) by using a numerical control program, the numerical control device (2) including:
a signal unit (26) that controls an action of the numerical control device (2) in accordance with a signal state;
a control path selection unit (27) that selects a control path designated from a plurality of control paths including a control path for the external device in accordance with an input from the signal unit (26);
a display/operation unit (24) that allows state display of and an operation on the numerical control device (2);
an external device control path selection/operation unit (25) that provides, when a selection operation for the control path for the external device is performed on the display/operation unit (24), to the signal unit (26), a notification about switching to the control path for the external device to make the control path for the external device selectable and that provides, when an operation is performed on the display/operation unit (24) while the control path for the external device is selected, a notification to the signal unit (26) in accordance with the operation to make the control path for the external device operable;
an analysis unit (23) that analyzes an external device control command in the numerical control program during running of the control path for the external device;
an external device command signal generation unit (28) that generates, in accordance with the external device control command that the analysis unit (23) has analyzed, an external device command signal for executing an action of the external device (30); and
a transmission/reception unit (12) that transmits, to the control device (3), the external device command signal that the external device command signal generation unit (28) has generated.

### Note 2

In the numerical control device (2) described above,
the control path for the external device is disposed in a designated control path that is designated beforehand among the plurality of control paths, and
the external device control path selection/operation unit (25) provides, when a selection operation for the control path for the external device is performed on the display/operation unit (24), to the signal unit (26), a notification about switching to the designated control path.

### Note 3

In the numerical control device (2) described above,
the external device control path selection/operation unit (25) provides, when a selection operation for another control path is performed on the display/operation unit (24) while the control path for the external device is selected, to the signal unit (26), a notification about switching to the other control path to make the other control path selectable.

### Note 4

In the numerical control device (2) described above,
the external device control path selection/operation unit (25) provides, when a selection operation for at least one action mode among an editing mode for a numerical control program for the control path for the external device, a manual running mode, and an automatic running mode based on the numerical control program is performed on the display/operation unit (24), to the signal unit (26), a notification about switching to the action mode to perform a change to the action mode.

### Note 5

In the numerical control device (2) described above,
the external device control path selection/operation unit (25) provides, when an operation for starting or stopping of running based on a numerical control program for the control path for the external device is performed on the display/operation unit (24), to the signal unit (26), a notification about starting or stopping of running based on the numerical control program for the control path for the external device to perform starting or stopping of running of the external device.

### Note 6

In the numerical control device (2) described above,
the external device control path selection/operation unit (25) provides, when a changing operation of an action speed override value for the control path for the external device is performed on the display/operation unit (24), to the signal unit (26), a notification about changing of the action speed override value for the control path for the external device to update an action speed override value for the control device (3) to change an action speed override value for the external device (30).

### Note 7

In the numerical control device (2) described above,
the external device is a robot (30), and
the control device is a robot control device (3) that controls the robot.

### Note 8

A numerical control system (1) comprising:
the numerical control device (2); and
a control device (3) that is coupled to the numerical control device (2) and controls the external device (30).

### EXPLANATION OF REFERENCE NUMERALS

1 Numerical control system
2 Numerical control device
3 Robot control device (control device)
12, 13 Data transmission/reception unit (transmission/reception unit)
20 Machine tool
21, 31 Storage unit
22 Program input unit
23, 32 Analysis unit
24 Display/operation unit
25 Robot control path selection/operation unit (external device control path selection/operation unit)
26 Signal unit
27 control Path selection unit
28 Robot command signal generation unit (external device command generation unit)
29 Action control unit
30 Robot (external device)
30a Arm tip portion
30b Tool
33 Action instruction generation unit
34 Program management unit
35 Path control unit
36 Kinematics control unit
37 Servo control unit

1. A numerical control device that is coupled to an external device via a control device and controls the external device by using a numerical control program, the numerical control device comprising:
a signal unit that controls an action of the numerical control device in accordance with a signal state;
a control path selection unit that selects a control path designated from a plurality of control paths including a control path for the external device in accordance with an input from the signal unit;
a display/operation unit that allows state display of and an operation on the numerical control device;
an external device control path selection/operation unit that provides, when a selection operation for the control path for the external device is performed on the display/operation unit, to the signal unit, a notification about switching to the control path for the external device to make the control path for the external device selectable and that provides, when an operation is performed on the display/operation unit while the control path for the external device is selected, a notification to the signal unit in accordance with the operation to make the control path for the external device operable;
an analysis unit that analyzes an external device control command in the numerical control program during running of the control path for the external device;
an external device command signal generation unit that generates, in accordance with the external device control command that the analysis unit has analyzed, an external device command signal for executing an action of the external device; and
a transmission/reception unit that transmits, to the control device, the external device command signal that the external device command signal generation unit has generated.

2. The numerical control device according to claim 1, wherein the control path for the external device is disposed in a designated control path that is designated beforehand among the plurality of control paths, and the external device control path selection/operation unit provides, when a selection operation for the control path for the external device is performed on the display/operation unit, to the signal unit, a notification about switching to the designated control path.

3. The numerical control device according to claim 1, wherein the external device control path selection/operation unit provides, when a selection operation for another control path is performed on the display/operation unit while the control path for the external device is selected, to the signal unit, a notification about switching to the other control path to make the other control path selectable.

4. The numerical control device according to claim 1, wherein the external device control path selection/operation unit provides, when a selection operation for at least one action mode among an editing mode for a numerical control program for the control path for the external device, a manual running mode, and an automatic running mode based on the numerical control program is performed on the display/operation unit, to the signal unit, a notification about switching to the action mode to perform a change to the action mode.

5. The numerical control device according to claim 1, wherein the external device control path selection/operation unit provides, when an operation for starting or stopping of running based on a numerical control program for the control path for the external device is performed on the display/operation unit, to the signal unit, a notification about starting or stopping of running based on the numerical control program for the control path for the external device to perform starting or stopping of running of the external device.

6. The numerical control device according to claim 1, wherein the external device control path selection/operation unit provides, when a changing operation of an action speed override value for the control path for the external device is performed on the display/operation unit, to the signal unit, a notification about changing of the action speed override value for the control path for the external device to update an action speed override value for the control device to change an action speed override value for the external device.

7. The numerical control device according to claim 1, wherein
the external device is a robot, and
the control device is a robot control device that controls the robot.

8. A numerical control system comprising:
the numerical control device according to claim 1, and
a control device that is coupled to the numerical control device and controls the external device.
